(19) United States
(12) Patent Application Publication
(10) Pub. No.: US 2019/0379150 A1
(43) Pub. Date: Dec. 12, 2019

(54) COMPUTER HUB WITH ELECTRONIC RECEPTACLE THAT ADJUSTS IN VOLUME TO REGULATE ELECTRONIC CONNECTION

(71) Applicant: SARIANA, LLC, San Diego, CA (US)

(72) Inventors: Alan Turksu, San Diego, CA (US); Mustafa Burak Guclu, San Diego, CA (US)

(21) Appl. No.: 16/006,652

(22) Filed: Jun. 12, 2018

(51) Int. Cl. H01R 13/447; H01R 31/02; H01R 31/06

(52) U.S. Cl. CPC H01R 13/447; H01R 24/64; H01R 31/06; H01R 31/02

(57) ABSTRACT

A hub having a body configured to reversibly couple to a computer; and an electronic receptacle that reversibly adjusts in volume between a first configuration and a second configuration by movement of an adjustable cover that remains connected to the body in both configurations, wherein the first configuration is sized to prevent electronic connection to a peripheral connector and the second configuration is sized to accept electronic connection to a same peripheral connector, and wherein the electronic receptacle is exposed in the first configuration, thereby selectively permitting communication between the peripheral connector and the computer only when in the second configuration.

### TECHNICAL FIELD

The invention relates generally to electronic devices, and more specifically to a computer hub with an electronic receptacle that adjusts between two configurations, one of which prevents electronic communication with a peripheral connector and the other permits electronic communication with a same peripheral connector.

### BACKGROUND OF THE INVENTION

The field of consumer electronics includes a wide class of peripheral devices having varying purposes and functionalities. These devices and their abilities to meet consumer demands are often dependent upon their connection to a computer. With the increasing availability of diverse peripheral devices, a corresponding demand is increasing for hubs that electrically connect a single computer with multiple peripheral devices. An exemplary computer hub is shown in USD 711,884, which connects up to seven peripheral devices to a single computer by providing seven access ports.

While computer hubs are being developed to communicate with an increasing number of peripheral devices, there is also a need to decrease their size for storage and transportation. The dimensions of a hub are conventionally limited at least by the size of the corresponding peripheral connectors. Many peripheral connectors, such as USB-C connectors, are quite thin and thus more suited for hubs with slim profiles. Other connectors, such as RJ45 connectors for Ethernet connection are comparatively much larger. Therefore, there remains a challenge to develop computer hubs with slim profiles while also maintaining connectivity to larger peripheral connectors, such as RJ45 connectors.

### SUMMARY OF THE INVENTION

The invention addresses challenges inherent to conventional computer hub design and provides related benefits. In particular, the invention addresses the need to decrease the size of a computer hub, while maintaining the ability to electrically connect peripheral connectors having a large format. This is accomplished at least in part through a hub which includes an adjustable cover that controls access to an electronic receptacle by way of adjusting its volume via adjustably positioning the cover. More specifically, a hub is provided which includes a body configured to reversibly couple to a computer; and an electronic receptacle that reversibly adjusts in volume between a first configuration and a second configuration by movement of the adjustable cover, which remains connected to the body in both configurations. The first configuration is sized to prevent electronic connection to a peripheral connector, and the second configuration is sized to accept electronic connection to a same peripheral connector. Further, the electronic receptacle is exposed in the first configuration but selectively permits electronic communication between the peripheral connector and the computer only when in the second configuration. By adjusting the volume of the electronic receptacle, the profile of the hub can be reduced when stored or transported and can be selectively increased when requiring access to the electronic receptacle.

In preferred embodiments the adjustable cover follows a contour of an external surface of the body in the first configuration and breaks the contour in the second configuration. As such, the hub has a greater exposed surface area in the second configuration compared to the first configuration. Additionally, the electronic receptacle is prevented from adjusting from the second configuration to the first configuration while the peripheral connector, such as a RJ45 connector, is received but is permitted to do so when absent. In further preferred embodiments, the adjustable cover adjusts between the first configuration and the second configuration by a pivot movement.

In some embodiments, the adjustable cover is mounted to a pivot block for pivotal movement between the first configuration and the second configuration. In further preferred embodiments the pivot block includes a rod adapted for placement in a recess or aperture. In further preferred embodiments the pivot block is recessed in the body.

### BRIEF DESCRIPTION OF DRAWINGS

Embodiments of the invention can be better understood with reference to the following drawings, which form part of the specification and represent preferred embodiments. The components shown in the drawings are not necessarily to scale, emphasis instead being placed upon illustrating the principles of the invention. And, in the drawings, like reference numerals designate corresponding parts throughout the several views.

FIG. 1 depicts a partial exploded parts view of a hub 10 showing a mechanism for a pivot movement of the cover 16 and the electronic pins 30 for RJ45 electrical connection.

FIG. 2 depicts the electronic receptical 14 in a first configuration (closed) that prevents electrical connection.

FIG. 3 depicts the electronic receptical 14 in a second configuration (open) that permits electrical connection.

FIG. 4 depicts the electronic receptical 14 in the second configuration receiving a peripheral connector 18.

FIG. 5 depicts an isometric view of the hub 10 showing additional data ports 34.

FIG. 6 depicts an isometric view of the hub 10 electronically coupled to a computer 100 with a received peripheral connector 18.

### DETAILED DESCRIPTIONS OF PREFERRED EMBODIMENTS

For clarity of disclosure, and not by way of limitation, the invention is discussed according to various preferred embodiments. Furthermore, any examples provided are not intended to be limiting but rather exemplary as guidance for the skilled artisan.

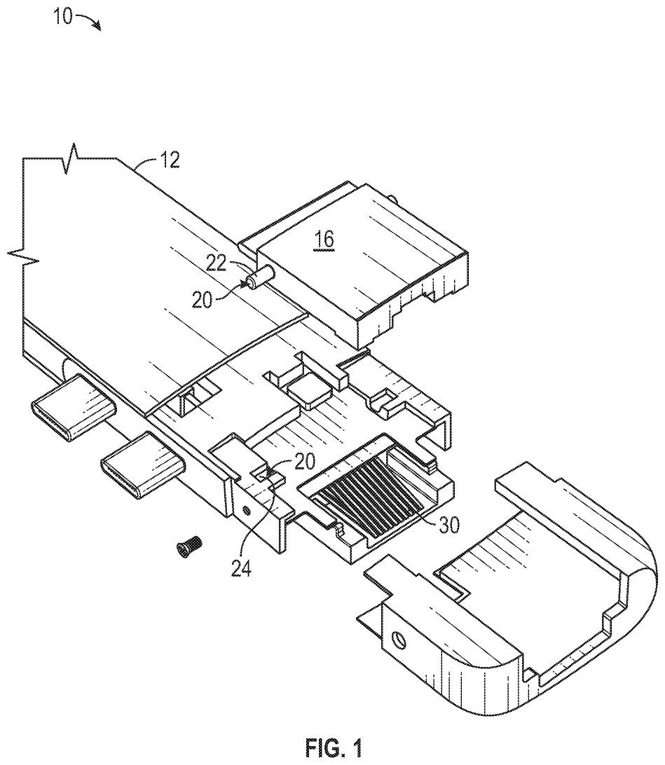

Now, referring collectively to FIGS. 1-6, a hub 10 for use with a computer 100 is provided, the hub 10 having a body 12 with an electronic receptacle 14 that reversibly adjusts in volume between a first configuration and second configuration by movement of an adjustable cover 16. The first configuration is sized to prevent electronic connection to a peripheral connector 18 and the second configuration is sized to accept receipt of a peripheral connector 18 for electronic connection. As such, electronic communication between the peripheral connector 18 and computer 100 is selectively permitted only in the second configuration. By providing a hub 10 that switches between two configurations, the hub 10 can be manufactured with a slimmer profile for improved storage while maintaining functionality with peripheral devices that require larger electronic receptacles 14 for communication.

As shown in FIGS. 1-3, the adjustable cover 16 can pivot from the first configuration to the second configuration by way of a pivot block 20. In such embodiments, the pivot block 20 can include complementary surfaces on the cover 16 and body 12 that permit pivoting, such as rod 22 and recess 24 or rod 22 and aperture (not shown). Preferably, the pivot block 20 is recessed below the contour of the body 12 such that as the cover 16 pivots on a pivot point or rod 22 the outer most end 26 of the cover 16 raises above the contour of the body 12 and the innermost end 28 sinks below the contour of the body 12, thereby breaking the contour. However, while not preferred, a pivot point or rod 22 at the contour of the body 12 could also be provided such that the outermost end 26 of the cover 16 raises above the countour of the body 12, while the innermost end 28 remains at the about the same place.

The phrase “contour of the body” as used herein refers to the outline, curvature or slope of the outer surface of the body 12. The phrase “follows the contour of the body” as used herein refers to a progression that does not abruptly deviate from the curvature or slope of the body 12 adjacent the cover 16. Thus, the phrase “follows the contour of the body” is to be assessed in the region(s) of the body 12 adjacent the cover 16. The phrase “breaks the contour of the body” as used herein refers to an abrupt change in surface contour between the body 12 and cover 16. To this end, a substantially flat cover 16 would follow the contour of the body 12 if the immediate adjacent portion of the body 12 is also substantially flat. Likewise, an arced cover 16 would follow the contour of the body 12 if the immediate adjacent portion of the body 12 is similarly arced. In contrast, a planar cover 16 would break the contour of the body 12 if the immediate adjacent portion of the body 12 was substantially arced. Likewise, a planar cover would break the contour of the body 12 if the immediate adjacent portion of the body 12 was also planar but on a plane that varies more than ten degrees from the plane of the cover 16. Determining whether the cover 16 follows the contour of the body 12 can be determined visually.

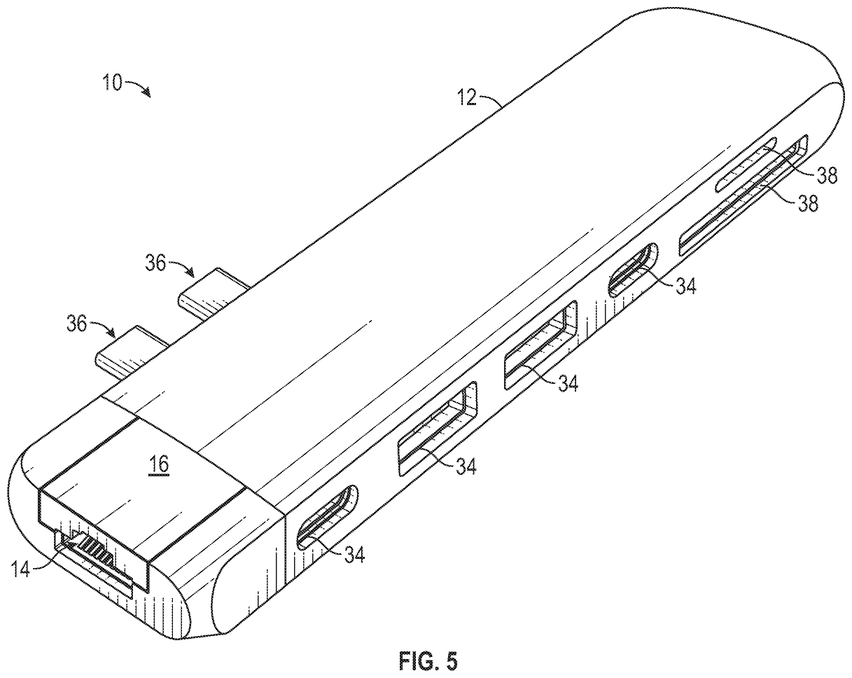

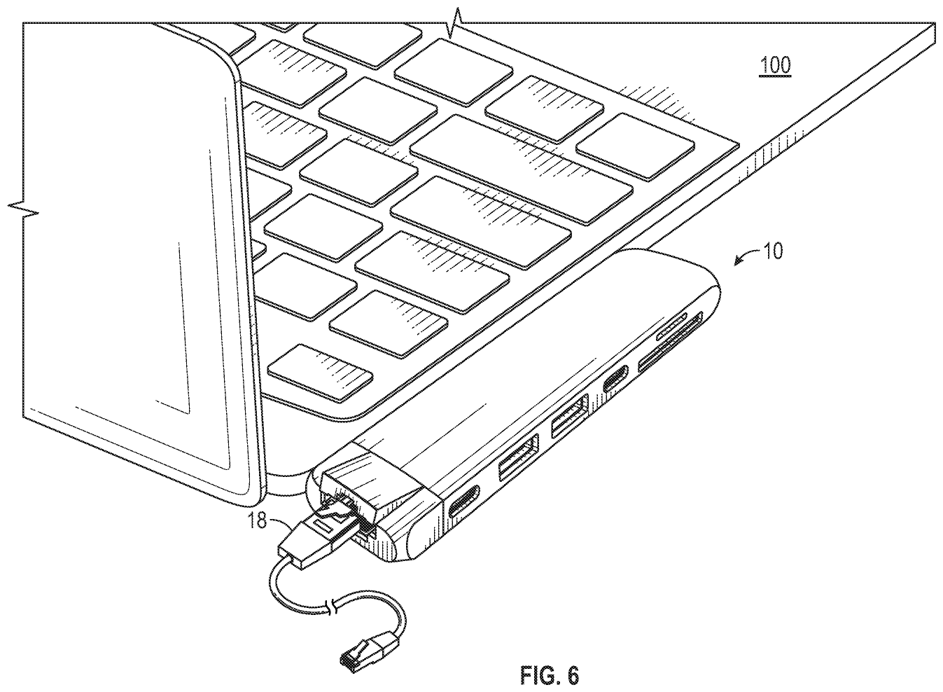

As shown in FIGS. 2 and 5, in the first configuration the adjustable cover 16 follows the contour of the body 12, which exposes the electronic receptacle 14 to the outer environment but prevents electronic communication between the electronic receptacle 14 and its corresponding peripheral connector 18 (depicted in FIG. 4). That is, in the first configuration the electronic receptacle 14 is not sized for electrical connection to a peripheral device, yet is visible. Thus, when in the first configuration (or closed position) the electronic receptacle 14 prevents electronic communication between a computer 100 and peripheral connector 18 (in contrast to FIG. 6) but is visually identifiable. In other words, the electronic receptacle 14 is exposed but too small to electrically engaging the peripheral connector 18 when in the first configuration. As such, the body 12 and cover 16 maintain a slim profile, yet visually identify the presence of the electronic receptacle 14 for opening.

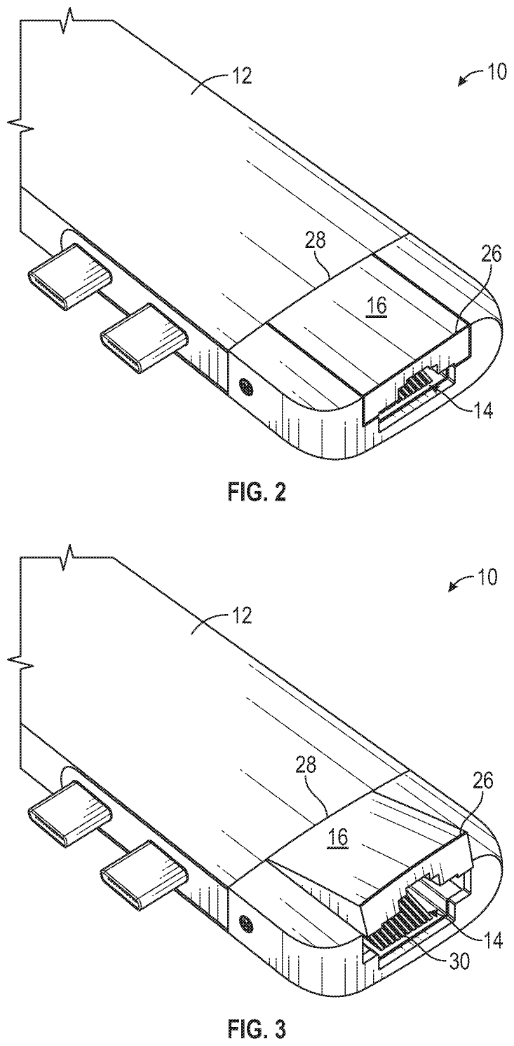

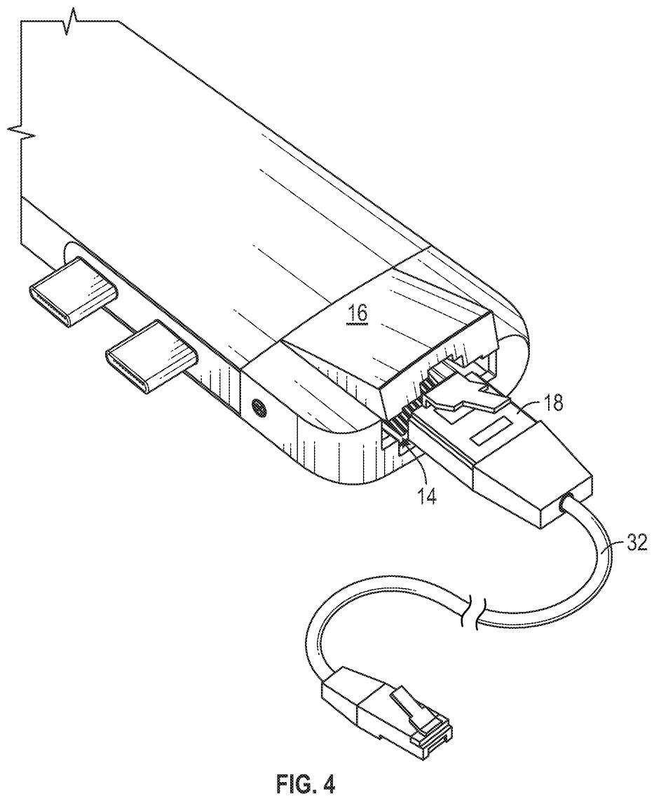

As shown in FIGS. 2 and 3, when the hub 10 adjusts from the first configuration (FIG. 2) to the second configuration (FIG. 3) both the total surface area and the total geometric volume of the hub 10 increases. Likewise, as the hub 10 adjusts from the second configuration (FIG. 3) to the first configuration (FIG. 2), both the total surface area and the total geometric volume of the hub 10 decreases. This change in total surface area and total geometric volume of the hub 10 is due to the changing height of the outermost end 26 of the cover 16 and the changing volume of the electronic receptacle 14, which is in response to the pivot angle and outermost end 26 of the cover 16.

Pivoting to the second configuration can be by way of release or activation of a spring or by way of a pressure release-capture mechanism. In some embodiments, the cover 16 is snap fit into its first configuration (FIG. 2) that follows the contour of the body 12 (closed position) and snap fit into its second configuration (FIG. 3) that breaks the contour of the body 12 (open position), where transititioning between the configurations is by way of manual movement with a user's fingers.

In other embodiments, the cover 16 is held in the first configuration (closed) by way of a spring force and transitioning to the second configuration is by way of inserting a perphereral connector 18, which sufficiently counters the spring force so that the cover 16 pivots outward to open the electronic receptacle 14 for electronic receipt of the peripheral connector 18. In such embodiments, removing the peripheral connector 18 releases the counter force, thereby causing the spring to pivot the cover 16 downward into the first configuration, and thus reduce the volume of the hub 10.

As shown in more detail in FIGS. 3-4, the peripheral connector 18 is permited to access the electronic receptacle 14 when in the second configuration. In particular, receipt of the peripheral connector 18 is by way of increasing the volume of the electronic receptable 14 to a suitable volume and presenting the internal surface of the electronic receptacle 14 in a format that complements the shape of the peripheral connector 18. Preferably, electronic pins 30 or connectors, which electrically connect the peripheral connector 18, are postioned opposite the cover 16 so that the movement between the first and second conifigurations does not require movement and thus wearing of the electronic pins 30 or connectors. However, in other embodiments, the electronic pins 30 or connectors are mounted to the underside of the cover 16 for connection to the peripheral connector 18 (not shown). In still other embodiments, the electronic pins 30 or connectors extend parallel to the body 12 along a male insert, which is itself recessed within the electronic receptacle 14, such as for electronically coupling to a male HDMI connector 18. Naturally, the electronic pins 30 can electrically connect the electronic receptacle 14 to the computer 100 by circuitry known in the art to which the invention belongs (see FIG. 6).

One of ordinary skill in the art to which the invention belongs would recognize that the arrangement of electronic pins 30 or connectors to electrically connect to the peripheral connector 18 within the electronic receptacle 14 may differ depening on the intended peripheral connector 18. Non-limiting examples of suitable receptacle 14—peripheral connector 18 complements include a 2.5 stereo jack, a 3.5 stereo jack, a 6.3 stereo jack, a BNC connector, a DB9 connector, a DB15 connector, a DB37 connector, a DB50 connector, a DVI-I connector, a Type F connector, a HDMI connector, a IEEE1394 connector (FIREWIRE), a Mini-DIN 4 connector, a Mini-DIN 6 connector, a Mini-DIN 8 connector, a Mini-DIN 13.2 connector, a Mini-VGA connector, a RCA connector, a RJ11 connector, a RJ12 connector, a RJ45 connector, a USB type A connector, a USB type B connector, a USB type C connector, a USB mini B connector, a USB micro B connector, a USB 3.0 Type A connector, a USB 3.0 Type B connector, a USB 3.0 Micro B connector, a USB 3.0 internal connector (20 pin) a USB 3.1 internal connector and others.

The artisan will appreciate that the perpheral connector 18 will typically be integral with a connecting cable 32, which connects to a peripheral device. The term “peripheral device” as used herein refers to an electronic device that includes input/output (I/O) functions for a computer 100 or hardware that connects a computer 100 to a computer network or Internet. Exemplary peripheral devices that may be electrically connected to the hub 10 include but are not limited to a network switch or router, a modem, an external hard drive, a mobile phone, a smart watch, a printer, a keyboard, a mouse, a monitor, a scanner and others. The peripheral connector 18 may connect to a computer network, such as via an RJ45 (Ethernet connector). Connection to a computer network through an Ethernet connector may be preferred when using a laptop computer 100 that is unable to connect via a wireless connection. When the peripheral connector 18 is electrically connected to the electronic receptical 14, the cover 16 may rest against the connector 18.

As shown in FIGS. 4-6, the hub 10 may include a single adjustable cover 16 with a single electronic receptacle 14, such as for an Ethernet connection, while providing other data ports 34 that also permit electronic connection with peripherals, such as via one or more selected from the group consisting of a 2.5 stereo jack, a 3.5 stereo jack, a 6.3 stereo jack, a BNC connector, a DB9 connector, a DB15 connector, a DB37 connector, a DB50 connector, a DVI-I connector, a Type F connector, a HDMI connector, a IEEE1394 connector (FIREWIRE), a Mini-DIN 4 connector, a Mini-DIN 6 connector, a Mini-DIN 8 connector, a Mini-DIN 13.2 connector, a Mini-VGA connector, a RCA connector, a RJ11 connector, a RJ12 connector, a RJ45 connector, a USB type A connector, a USB type B connector, a USB type C connector, a USB mini B connector, a USB micro B connector, a USB 3.0 Type A connector, a USB 3.0 Type B connector, a USB 3.0 Micro B connector, a USB 3.0 internal connector (20 pin) a USB 3.1 internal connector and others. When providing only a single adjustable cover 16 with a single electronic receptacle 14, the electronic receptacle 14 can be positioned along a width of the body 12 as shown in FIGS. 1-6 or can be positioned long a length. When positioned along a width, the adjustable cover 16 and electronic receptacle 14 can be positioned along a front or rear of the body 12. When positioned along a length, the adjustable cover 16 and electronic receptacle 14 can be positioned along either a left side or a right side. Positioning may be determined based on the connecting orientation with the computer 100 and the connecting orientation of the peripheral. For instance, if providing an electronic receptacle 14 for connecting to a network via an Ethernet port, the electronic receptacle 14 would most preferably be positioned along a width of the body and along the rear as shown in FIG. 6.

In some embodiments, a single adjustable cover 16 spans two or more electronic receptacles 14, each able to electrically connect a same or different type of connector 18, so that a first configuration prevents electrical connection to each of the electronic reptacles 14 that share the cover 16 and a second configuration permits electrical connection to each of the electronic receptacles 14 that share the cover 16. In further embodiments the cover 16 spans three electronic receptacles 14 for switching between configurations across the three electronic receptacles 14 simultaneously. In futher embodiments, the cover 16 spans four electronic receptacles 14 for switching between configurations across the four electronic receptacles 14 simultaneously. In further embodiments, the cover 16 spans five electronic receptacles 14 for switching between configurations across the five electronic receptacles 14 simultaneously. In further embodiments, the cover 16 spans six electronic receptacles 14 for switching between configurations across the six electronic receptacles 14 simultaneously. In further embodiments, the cover 16 spans seven electronic receptacles 14 for switching between configurations across the seven electronic receptacles 14 simultaneously. When spanning two or more electronic receptacles 14 with a same cover 16, it is generally preferred to provide the electronic receptacles 14 along a length of the body 12.

In some embodiments, a plurality of electronic receptacles 14 are provided on a single hub 10, where each of the plurality of electronic receptacles 14 is provided with an adjustable cover 16 that actuates independent of the other covers 16, thereby opening and closing each of the electronic receptacles 14 independently. In some embodiments, two electronic receptables 14 are paired with two covers 16 so that each cover 16 transitions between a first configuration and a second configuration independent of the other to independently permit access to each electronic receptacle 14. In some embodiments, three electronic receptables 14 are paired with three covers 16 so that each cover 16 transitions between a first configuration and a second configuration independent of the other two to independently permit access to each electronic receptacle 14. In some embodiments, four electronic receptables 14 are paired with four covers 16 so that each cover transitions between a first configuration and a second configuration independent of the other three to independently permit access to each electronic receptacle 14.

As shown collectively in FIGS. 5-6, the hub 10 can be plugged directly into the computer 100, such as by way of connecting terminals 36 or can be connected wirelessly. If by way of connecting terminals 36, such terminals 36 are conventionally male terminals 36 for insertion into female ports on the computer 100 but could be female terminals 36 requiring a connecting cable. Non-limiting examples of connecting terminals 36 include those such as, but not limited to USB type A, B or C terminals 36 and others. In some embodiments, the hub 10 has two USB-C terminals 36. The hub can also include card reading function for memory cards, and thus have one or more card reading ports 38.

The hub 10 may have additional connectivity capabilities as well such as the capability to connect to wireless personal area networks, wireless local area networks, wireless metropolitan area networks. These networks can be, but not limited to, in the form of Bluetooth, ZigBee, near field communication (NFC), IEEE 802.11 (Wi-Fi) and IEEE 802.15 (WiMAX). The wireless connectivity of the hub 10 removes some potential limitations in connectivity of the hub 10.

Having described the invention in detail, it will be apparent that modifications, variations, and equivalent embodiments are possible without departing from the scope of the invention defined in the claims.

1. A hub comprising:
(a) a body configured to reversibly couple to a computer; and
(b) an electronic receptacle that reversibly adjusts in volume between a first configuration and a second configuration by movement of an adjustable cover that remains connected to the body in both configurations by a pivot block formed by a body recess that accepts a rod from the cover, wherein the first configuration is sized to prevent electronic connection to a peripheral connector and the second configuration is sized to accept electronic connection to the same peripheral connector, and wherein the electronic receptacle is exposed in the first configuration, thereby selectively permitting communication between the peripheral connector and the computer only when in the second configuration.

2. The hub of claim 1, wherein the adjustable cover follows a contour of an external surface of the body in the first configuration and breaks the contour in the second configuration.

3. The hub of claim 1, wherein the adjustable cover is prevented from adjusting from the second configuration to the first configuration when the peripheral connector is received.

4. The hub of claim 1, wherein the movement of the adjustable cover comprises a pivot movement.

5-7. (canceled)

8. The hub of claim 1, wherein the hub has a greater exposed surface area in the second configuration compared to the first configuration.

9. The hub of claim 1, wherein the peripheral connector is a RJ45 connector.

10. The hub of claim 1, wherein the first configuration is held in place by way of a spring force.

11. The hub of claim 1, wherein the pivot block is covered by an end piece that slides over the recess.
